(19) United States
(12) Patent Application Publication
(10) Pub. No.: US 2004/0044128 A1
(43) Pub. Date: Mar. 4, 2004

(54) Method and microcapsule compound waterborne polyurethane

(75) Inventors: Yen-Shyi Lin, Tu-Chen City (TW); Chun-Hung Lin, Tu-Chen City (TW); Lien-Hua Chiu, Tu-Chen City (TW); Shu-Lan Yao, Tu-Chen City (TW); Cheng-Chu Lin, Tu-Chen City (TW)

Correspondence Address: TROXELL LAW OFFICE PLLC, 5205 LEESBURG PIKE, SUITE 1404, FALLS CHURCH, VA, 22041, US

(73) Assignee: China Textile Institute

(21) Appl. No.: 10/230,983

(22) Filed: Aug. 30, 2002

(51) Int. Cl. B01J 13/00

(52) U.S. Cl. 525/63; 264/4

(57) ABSTRACT

The present invention provides a method and microcapsule compound waterborne polyurethane wherein further comprises forming homogeneous dispersive liquid from the compound process of waterborne polyurethane prepolymer added water solution of microcapsules with waterborne polyurethane shell for the phase change material and the present invention of the method further adds curing agent, antifoam and thickener for coating fabrics.

### FIELD OF THE INVENTION

The present invention relates to a forming homogeneous dispersive liquid, particularly to a method and microcapsule compound waterborne polyurethane.

### BACKGROUND OF THE INVENTION

At the phase change temperature, a characteristic of phase change material during solid/liquid transition cycle is to absorb and release a quantity of latent heat. In general, the material can be used as a barrier to heat, since a quantity of latent heat must be absorbed by the phase change material before its temperature can rise. Similarly, the phase change material may be used as a barrier to cold, as a quantity of latent heat must be removed from the phase change material before its temperature can begin to drop.

The phase change material provides further improvement of fabric insulation volume and insulated ability. The applied phase change material is a standard insulated material, when non-woven is selected. The phase change materials are selected from the different thermo coefficient of materials that absorb and release the large amounts of latent heat to provide insulation by changing the solid to liquid and back, wherein the latent heat quantity is controllable and depending on the thermo coefficient of materials.

Applied phase change materials in fabric area are commonly supplied as microencapsulated form for coating fabrics, that provides not only latent heat, but also breathability, flexibility, washability, durability and resistance to the change of heat or pressure and chemicals during the coating process.

The present invention provides a method and microcapsule compound waterborne polyurethane wherein further comprises forming homogeneous dispersive liquid from the compound process of waterborne polyurethane prepolymer added water solution of microcapsules of waterborne polyurethane shell for phase change material.

The important prior art patent of method of change phase materials for microcapsules follows the list.

Triangle Research and Development Corporation, U.S. Pat. No. 5,366,801, Fabric with reversible enhanced thermal properties, which discloses coating fabrics of microcapsules with paraffin hydrocarbon core (CₙH₂ₙ₊₂. subscript n from 13 to 28) for the solid/liquid transition from 0 to 80° C. by adding polymeric binder. The said polymeric binder is selected from the group consisting of polyurethane, nitrile rubber, chloroprene rubber, polyvinyl alcohol, silicone, ethylene/vinyl acetate copolymer and acrylic, and then the said polymeric binder adds plastic crystals. Thus, it can obtain a fact of commercial value of a phase change material for microcapsules. The present invention of a method and microcapsule compound waterborne polyurethane disclosures a alkyl alkyrate (alkyric acid alkyl ester) for phase change materials. The carbon atom alkyl of said alkyl alkyrate (alkyric acid alkyl ester) is from 1 to 26 and the carbon atom alkyrate of said alkyl alkyrate (alkyric acid alkyl ester) is from 1 to 12. Thus, the said alkyl alkyrate (alkyric acid alkyl ester) is substituted for paraffin hydrocarbon and capable of undergoing heat storage (release) material for the solid/liquid transition from 0° C. to 80° C. Therefore, the present Invention is more useful.

Frisby Technologies, Inc., U.S. Pat. No. 6,270,836, Gel-coated microcapsules, discloses coating fabrics of microcapsules with a phase change material core by sol gel method for continuous metal oxide gel coating. The phase change material is selected from the group consisting of paraffin hydrocarbon (CₙH₂ₙ₊₂, subscript n from 10 to 30), 2,2-dimethyl-1,3-propanediol (DMP), 2-hydroxymethyl-2-methyl-1,3-propanediol (HMP) and methyl palmitate. Thus, it can obtain another face of commercial value of the phase change material for microcapsules in a greater area. The present invention provides flexible and no-fragile microcapsules with waterborne polyurethane shell for coating fabrics, which is non-obviousness.

Outlast Technologies, Inc., U.S. Pat. No. 6,207,738, Fabric coating composition containing energy absorbing phase change material, discloses coating fabrics of wet microcapsules with paraffin hydrocarbon core (CₙH₂ₙ₊₂, subscript n from 13 to 28) by adding Polymeric binder, surfactant, dispersant, antifoam agent and thickener. Thus, it can obtain the other face of commercial value of phase change material for microcapsules in a greater area. The present invention provides a homogeneous dispersive liquid with curing agent, antifoam and thickener for coating fabrics. Therefore, it contains novelty.

### OBJECT OF THIS INVENTION

Therefore, the present invention provides a method and microcapsule compound waterborne polyurethane.

The main object of the present invention is to provide flexible and no-fragile microcapsules with phase change material core which uses interfacial condensation polymerization.

Another object of the present invention is to provide a homogeneous dispersive liquid from the compound process added water solution of microcapsules of waterborne polyurethane and reduced containing water.

The other object of the present invention is to provide a alkyl alkyrate (alkyric acid alkyl ester) which is substituted for paraffin hydrocarbon for phase change material and capable of the solid/liquid transition from 0° C. to 80° C.

### SUMMARY OF THE INVENTION

The present invention of a method and microcapsule compound waterborne polyurethane, wherein phase change material of microcapsules with waterborne polyurethane shell which use interfacial condensation polymerization with alkyl alkyrate (alkyric acid alkyl ester) core. The carbon atom alkyl of said alkyl alkyrate (alkyric acid alkyl ester) is from 1 to 26 the carbon atom alkyrate of said alkyl alkyrate (alkyric acid alkyl ester) is from 1 to 12, and the solid/liquid transition temperature is from 0° C. to 80° C. The method further adds curing agent, antifoam and thickener for coating fabrics. Thus, it can obtain a fact of commercial value of phase change material for microcapsules.

### BRIEF DESCRIPTION OF THE DRAWINGS

The present invention will be better understood from the following detailed description of preferred embodiments of the invention, taken in conjunction with the accompanying flow diagram, in which

TABLE 1 and TABLE 2 are preferred embodiments of homogeneous dispersive liquid formulation.

TABLE 3 is a preferred embodiment of coating fabric formulation.

FIG. 1 is a flow diagram showing the methodology for homogeneous dispersive liquid of microcapsules with waterborne polyurethane shell for the phase change material.

### DESCRIPTION OF THE PREFERRED EMBODIMENTS

The following descriptions of the preferred embodiments are provided to understand the features and the methods of the present invention.

The present invention provides a method and microcapsule compound waterborne polyurethane wherein further comprises forming homogeneous dispersive liquid from the compound process of waterborne polyurethane prepolymer added water solution of microcapsules with waterborne polyurethane shell for the phase change material, and the said homogeneous dispersive liquid added curing agent, antifoam and thickener to coat fabrics, wherein the fabrics is selected from the group consisting of woven, non-woven and structure of woven. The said waterborne polyurethane is selected from the group consisting of 2,2-bis (hydroxymethyl) propionic acid-triethylamine, sodium sulfite salt and mixtures thereof. Microcapsules suitable for the present invention contain waterborne polyurethane materials. The temperature for microcapsules is in the range of 0° C. to 80° C. with alkyl alkyrate (alkyric acid alkyl ester) that the carbon atom alkyl is from 1 to 26 and the carbon atom alkyrate is from 1 to 12 by using interfacial condensation polymerization.

The present invention is illustrated in detail with the following examples, which should not be construed as limiting the scope of the invention.

### EXAMPLE 1

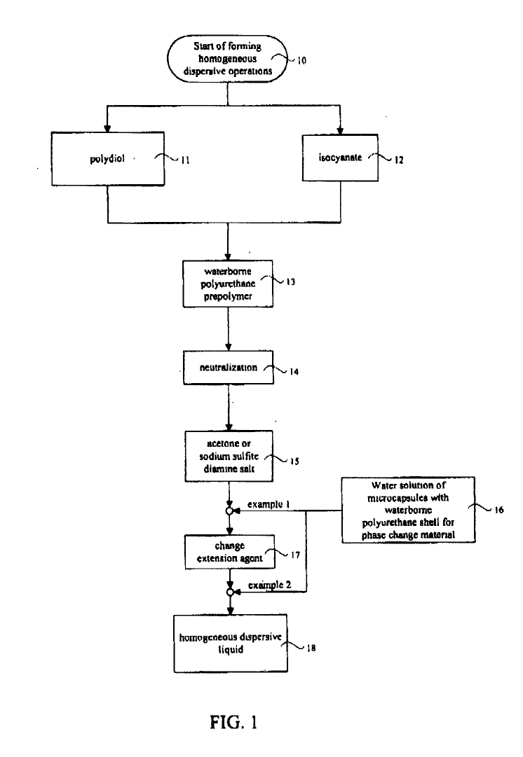

Referring to the FIG. 1 and TABLE 1, this invention discloses a method and microcapsule compound waterborne polyurethane. FIG. 1 is a flow diagram showing the methodology for homogeneous dispersive liquid of microcapsules with waterborne polyurethane shell for a phase change material. Start indication block 10 indicates the polydiol block 11 and isocyanate block 12 is executed. The polydiol block 11 titrate the amount of free isocyanate block 12 to compound waterborne polyurethane prepolymer block 13, and then neutralization block 14 is executed. At neutralization block 14, the waterborne polyurethane prepolymer block 13 is neutralized by triethylamine. The execution of block 15 in neutralization block 14 acetone or sodium sulfite diamine salt is added, and then block 18 is executed. The water solution of microcapsules with waterborne polyurethane shell for phase change material is then added and stired to disperse. The block 17 is added the change extension agent. Therefore, the block 18 is formed with homogeneous dispersive liquid from the compound process of waterborne polyurethane prepolymer added water solution of microcapsules with waterborne polyurethane shell for phase change material.

### EXAMPLE 2

Referring to FIG. 1 and TABLE 2 this invention discloses a method and microcapsule compound waterborne polyurethane. FIG. 1 is a flow diagram showing the methodology for homogeneous dispersive liquid

of microcapsules with waterborne polyurethane shell for the phase change material, Start indication block 10 indicates the polydiol block 11 and isocyanate block 12 is executed. The polydiol block 11 titrate the amount of free isocyanate block 12 to compound waterborne polyurethane prepolymer block 13, and then neutralization block 14 is executed. At neutralization block 14, the waterborne polyurethane prepolymer block 13 is neutralizaed by triethylamine. To execute block 15, acetone or sodium sulfite diamine salt is added in neutralization block 14. The block 17 is added the change extension agent, and then block 16 is executed, The water solution of microcapsules with waterborne polyurethane shell for the phase change material is then added and stired to disperse. Therefore, the block 18 is formed with homogeneous dispersive liquid from the compound process of waterborne polyurethane prepolymer added water solution of microcapsules with waterborne polyurethane shell for the phase change material

### EXAMPLE 3

The present invention further obtains another face of commercial value of coating fabrics in a greater area. Referring to TABLE 3, this invention discloses the method added curing agent, antifoam and thickener for coating fabrics. The said curing agent is selected from the group consisting of melamine curing agent, isocyanate curing agent and mixtures thereof.

The present invention does not only possess a better practicality, neither only a conception based on familiarity of utilization, it is non-obviousness and useful, which comprise:

1. The flexible and no-fragile microcapsules with phase change material core use interfacial condensation polymerization by waterborne polyurethane thereof, when producing coated fabrics. Therefore, it contains novelty.

2. The present invention provides a homogeneous dispersive liquid from the compound process of waterborne polyurethane prepolymer added water solution of microcapsules of waterborne polyurethane shell for the phase change material. Therefore, it is easy to reduce containing water, which is non-obviousness.

3. The present invention provides a alkyl alkyrate (alkyric acid alkyl ester) for the phase change material. Thus, the said alkyl alkyrate (alkyric acid alkyl ester) is substituted for paraffin hydrocarbon and capable of undergoing heat storage (release) material for the solid/liquid transition from 0° C. to 80° C.

4. The present invention provides a homogeneous dispersive liquid added curing agent, antifoam and thickener for coating fabrics. It further obtains another face of commercial value of coating fabrics in a greater area, which is useful.

The present invention may be embodied in other specific forms without departing from the spirit of the essential attributes thereof; therefore, the illustrated embodiment should be considered in all respects as illustrative and not restrictive, reference being made to the appended claims rather than to the foregoing description to indicate the scope of the invention.

TABLE 1

| Item | Component |
|---|---|
| waterborne polyurethane prepolymer | 2,2-Bis (hydroxymethyl) propionic acid - |
| | triethylamine, sodium sulfite salt or mixtures thereof |
| Water solution of microcapsules with | waterborne polyurethane with phase change |
| waterborne polyurethane shell for phase | materials shell core, wherein phase change |
| change material | materials contain alkyl alkyrate (alkyric acid |
| | alkyl ester) |
| change extension agent | amine change extension agent |

TABLE 2

| Item | Component |
|---|---|
| waterborne polyurethane prepolymer | 2,2-Bis (hydroxymethyl) propionic acid - |
| | triethylamine, sodium sulfite salt or mixtures thereof |
| change extension agent | amine change extension agent |
| Water solution of microcapsules with | waterborne polyurethane with phase change materials |
| waterborne polyurethane shell for phase | shell core, wherein phase change materials contain |
| change material | alkyl alkyrate (alkyric acid alkyl ester) |

TABLE 3

| Item | Component |
|---|---|
| curing agent | melamine curing agent, isocyanate curing |
| | agent and mixtures thereof |
| antifoam agent | silicone oil and dispersed fine particle silica |
| Thickener | polyacrylic acid, cellulose esters and their |
| | dervative, polyvinyl alcohol and mixtures |
| | thereof |

What is claimed is:

1. A method and microcapsule compound waterborne polyurethane wherein further comprises forming homogeneous dispersive liquid from the compound process of waterborne polyurethane prepolymer added water solution of microcapsules with waterborne polyurethane shell for the phase change material.

2. A method and microcapsule compound waterborne polyurethane of claim 1, wherein said the phase change material is selected from the consisting of alkyl alkyrate (alkyric acid alkyl ester) and mixtures of alkyl alkyrate (alkyric acid alkyl ester).

3. A method and microcapsule compound waterborne polyurethane of claim 2, wherein the carbon atom alkyl of said alkyl alkyrate (alkyric acid alkyl ester) is from 1 to 26.

4. A method and microcapsule compound waterborne polyurethane of claim 2, wherein the carbon atom alkyrate of said alkyl alkyrate (alkyric acid alkyl ester) is from 1 to 12.

5. A method and microcapsule compound waterborne polyurethane of claim 1, wherein said microcapsules with waterborne polyurethane shell encapsulate the phase change material by interfacial condensation polymerization.

6. A method and microcapsule compound waterborne polyurethane of claim 1, wherein said waterborne polyurethane is selected from the group consisting of 2,2-bis (hydroxymethyl) propionic acid-triethylamine, sodium sulfite salt and mixtures thereof.

7. A method and microcapsule compound waterborne polyurethane of claim 1, wherein said method further addd curing agent, antifoam and thickener for coating fabrics.

8. A method and microcapsule compound waterborne polyurethane of claim 7, wherein said fabric is a woven.

9. A method and microcapsule compound waterborne polyurethane of claim 7, wherein said fabric is a non-woven.

10. A method and microcapsule compound waterborne polyurethane of claim 7, wherein said fabric is a structure of woven.

11. A method and microcapsule compound waterborne polyurethane of claim 7, wherein curing agent is selected from the group consisting of melamine curing agent isocyanate curing agent and mixtures thereof.
